(19) United States
(12) Patent Application Publication
(10) Pub. No.: US 2018/0190328 A1
(43) Pub. Date: Jul. 5, 2018

(54) Mountable Video Recording and Streaming System

(71) Applicant: Michael Criscuolo, Del Mar, CA (US)

(72) Inventor: Michael Criscuolo, Del Mar, CA (US)

(21) Appl. No.: 15/859,865

(22) Filed: Jan. 2, 2018

Related U.S. Application Data
(60) Provisional application No. 62/440,674, filed on Dec. 30, 2016.

(51) Int. Cl. G11B 33/02; H04N 7/18; H04N 5/232; H04N 5/225; H04N 5/77; G11B 31/00; G11B 33/12

(52) U.S. Cl. CPC G11B 33/022; H04N 7/181; H04N 5/23241; G11B 33/123; H04N 5/77; G11B 31/006; G11B 33/122; H04N 5/2252

(57) ABSTRACT

A surveillance system which provides a user with direct and remote access via cellular, wireless or hard-wired connection, to multiple high definition digital video streams from one device. The surveillance system includes a housing enclosure, a plurality of surveillance cameras, an internal storage device, a power-management computing device, a video-management computing device, a wireless communication router, and a power supply. The plurality of surveillance cameras is distributed and connected about a bottom surface of the housing enclosure. The internal storage device stores content from the surveillance cameras for a significantly long time, reducing the need for constant content download. The power-management computing device and the video-management computing device control the surveillance system. The wireless communication router allows for the user to remotely access content from the surveillance cameras and control any component within the surveillance system. The power supply provides the electrical energy necessary to power the aforementioned components.

The current application claims a priority to the U.S. Provisional Patent application Ser. No. 62/440,674 filed on Dec. 30, 2016.

### FIELD OF THE INVENTION

The present invention relates generally to a system providing the user direct and remote access via cellular, wireless or hard-wired connection, to multiple high definition digital video streams whether live, or recorded, simultaneously from one device. In particular, the present invention comprises a video recording and streaming system enclosed in an outdoor rated polycarbonate enclosure that can be accessed and controlled locally or remotely.

### BACKGROUND OF THE INVENTION

The present invention is a mountable video recording, storing and streaming system. The present invention provides the user with remote access via a cellular, wireless or hard-wired connection to the recorded data, onboard devices, and onboard climate control systems. Additionally, the whole system is housed in a weather tight polycarbonate enclosure, thus ensuring sustained operation even in the most of extreme environments. Most surveillance cameras typically can store only a few days of video footage onboard. If the customer wants to view and store the footage, then they must download on a regular basis and store the video on another device. If they are retrieving the video via a cellular device, the cost to stream the video is very high. The present invention allows the user to store up to three months of video onboard, which drastically reduces the number of downloads required. Additionally, because present invention houses an on-board windows based computer, most all video management systems can be loaded to this computer which allows the user to perform video analytics at the edge which can be stored or accessed in real-time.

Along with the hardware, the present invention also includes a graphical user interface that allows the user to communicate with the internetworked devices via the internet, from any smart device anywhere in the world. The user interface can be accessed remotely and provides the user two-way communication to the on-board devices. Resultantly, the user has access to information such as internal enclosure temperature, pre-programmed pre-sets for climate control, self-cleaning, start-up parameters, power consumption, current load, and 24-hour power and temperature graphs. The user can remotely re-boot the onboard devices in the event of a device failure. Traditionally, if a device failure occurs, a service technician would have to be dispatched to manually re-boot the device.

When designing surveillance systems for specific areas of coverage, systems integrators will survey the area and determine the type and numbers of equipment required to provide the level of coverage desired by the customer. In many cases there is a need for multiple cameras to be installed in the same location, that face in different locations. In addition, the camera type may not be the same. Therefore, the integrator needs to source different camera systems, i.e. one camera with a six millimeter lens, one camera with ability to read license plates, and one camera that has infrared sensors. The present invention can accommodate a variety of camera models and integrate them into one system. This saves the integrator time and money. The present invention can also be rapidly deployed in a matter of minutes through a quick two-piece mounting system and wireless/cellular connection to the Internet.

### BRIEF DESCRIPTION OF THE DRAWINGS

FIG. 1 is a perspective view of the present invention.

FIG. 2 is a rear perspective view of the present invention with a housing enclosure in an open state.

FIG. 3 is a bottom perspective view of the present invention in a partially exploded configuration.

FIG. 4 is a main electric schematic of the present invention.

FIG. 5 is an electronic schematic of the present invention.

FIG. 6 is a secondary electric schematic of the present invention.

### DETAIL DESCRIPTIONS OF THE INVENTION

All illustrations of the drawings are for the purpose of describing selected versions of the present invention and are not intended to limit the scope of the present invention.

The present invention generally relates to surveillance systems. More specifically, the present invention is a mountable video recording and streaming system. The present invention provides surveillance coverage of an area with relatively low required maintenance.

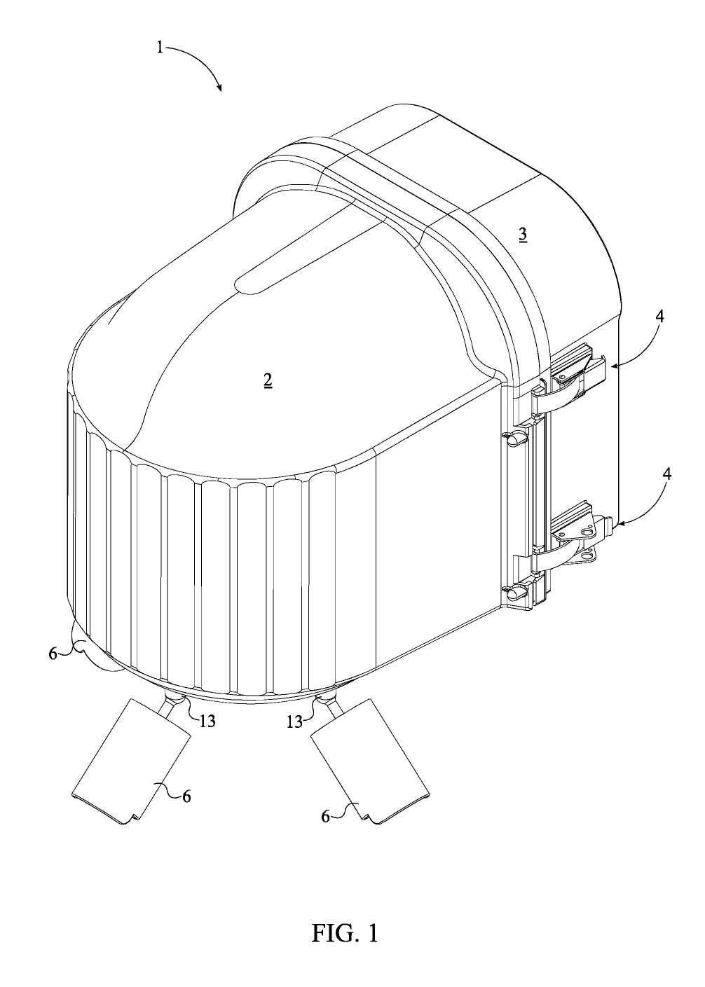

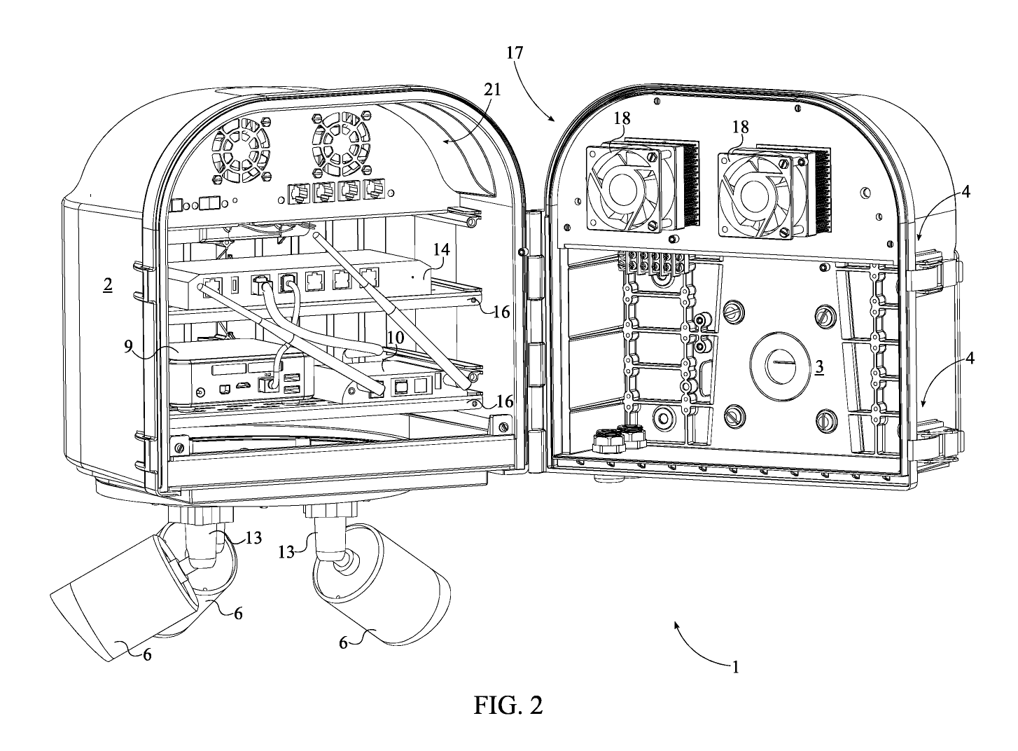

Referring to FIG. 1 and FIG. 2, the present invention comprises a housing enclosure 1, a mounting bracket 12, a plurality of surveillance cameras 6, an at least one internal storage device 7, a power-management computing device 8, a video-management computing device 9, a wireless communication router 10, a power supply 11, and a network switch 14. The housing enclosure 1 is a weatherproof enclosed space which supports and protects the electronical components of the present invention. More specifically, the housing enclosure 1 comprises a front portion 2, a rear portion 3, and an at least one fastening mechanism 4. The front portion 2 and the rear portion 3 delineate an interior storage space. The housing enclosure 1 is preferably a weather tight polycarbonate enclosure, although alternative materials and designs may also be used. More specifically, the front portion 2 makes up the body of the housing enclosure 1 and the rear portion 3 is the backing of the housing enclosure 1. The rear portion 3 is positioned adjacent to a main cavity 21 of the front portion 2. Additionally, the rear portion 3 is hingedly attached to the front portion 2. This provides a means for accessing the components within the housing enclosure 1 for customization and maintenance purposes. The fastening mechanism 4 is mechanically integrated in between the front portion 2 and the rear portion 3 in order to lock and secure the front portion 2 to the rear portion 3, resulting in a weatherproof enclosure. In the preferred embodiment of the present invention, the fastening mechanism 4 includes a first fastener and a second fastener, wherein different mechanisms are used as the first fastener and the second fastener. The mounting bracket 12 attaches the housing enclosure 1, and thus the present invention, to an external structure such as a side of building or a pole. The mounting bracket 12 is a planar structure that is perpendicularly oriented to the bottom surface 5. To mount the present invention, the mounting bracket 12 is first attached to the external structure through fasteners such as screws, bolts, adhesive, or other similar mechanisms. Next, the housing enclosure 1 is positioned adjacent to the mounting bracket 12 and the mounting bracket 12 is externally and adjacently connected to the rear portion 3. In the preferred embodiment of the present invention, the rear portion 3 includes a bracket-receiving slot that is sized to interlock with the mounting bracket 12. In this embodiment, the mounting bracket 12 is first attached to the external structure. Next, the housing enclosure 1 is positioned adjacent to the mounting bracket 12 with the rear portion 3 being positioned adjacent to the mounting bracket 12. Then, the mounting bracket 12 is slid within the bracket-receiving slot and or interlocked with the bracket-receiving slot. Finally, the rear portion 3 is attached to the mounting bracket 12 through fasteners such as screws, bolts, and adhesive to name a few non-limiting examples.

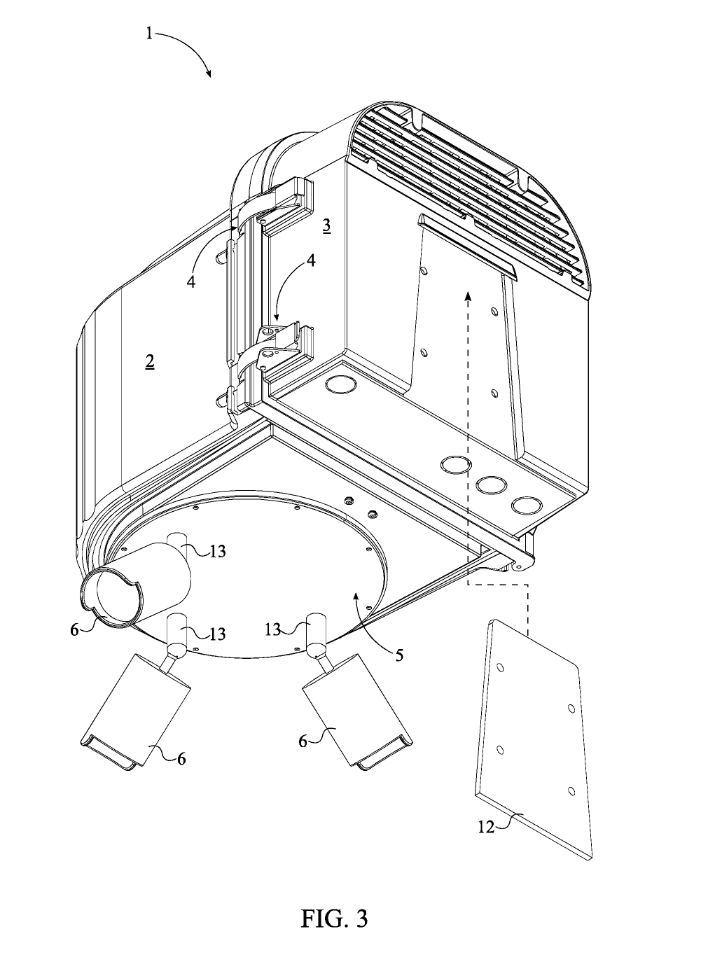

The plurality of surveillance cameras 6 records or captures images of the area around the housing enclosure 1 to allow a user to monitor and observe activities within the vicinity around the present invention. The plurality of surveillance cameras 6 is distributed about a bottom surface 5 of the housing enclosure 1. Resultantly, the housing enclosure 1 acts as a protection for the plurality of surveillance cameras 6 against rain, hail, snow, and other environmental factors. In particular, each of the plurality surveillance cameras 6 is externally mounted to the bottom surface 5 as seen in FIG. 3. In one embodiment of the present invention, the plurality of surveillance cameras 6 comprises three high-definition four mega-pixel digital cameras that are positioned in a triangular pattern on the bottom surface 5. This provides the user with high quality video feed from a multitude of angles. The plurality of surveillance cameras 6 may also include most all fixed outdoor cameras, license plate readers, thermal cameras, network cameras, and other similar cameras that can be accessed and controller by the internet. Each of the plurality of surveillance cameras 6 comes equipped with analytical software and user controls to set video parameters such as motions sensing, line tracking, boundaries, and to send email alerts. Each of the plurality of surveillance cameras 6 also has the ability to be remotely rebooted, thus reducing the need for onsight maintenance.

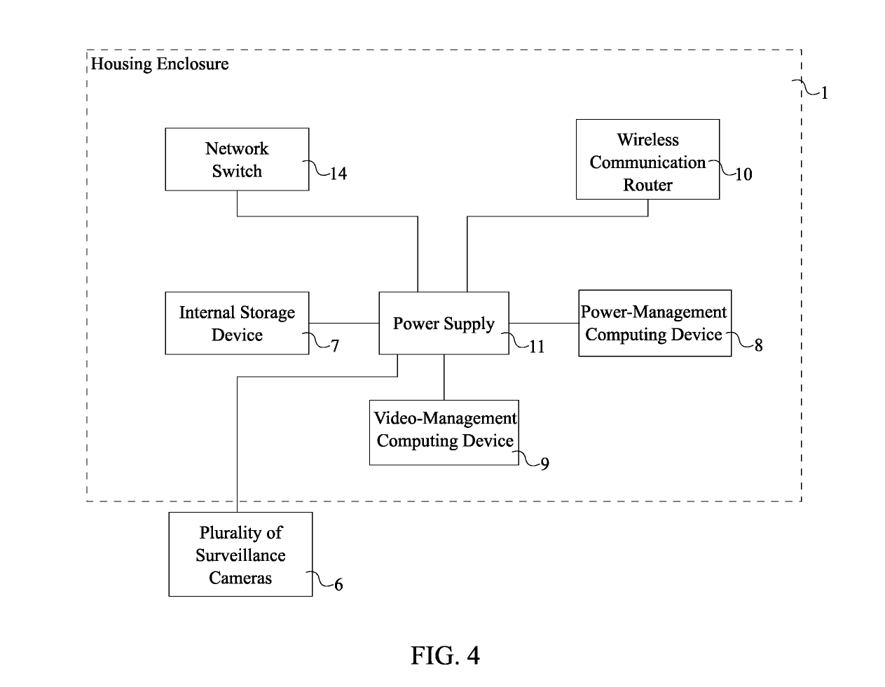

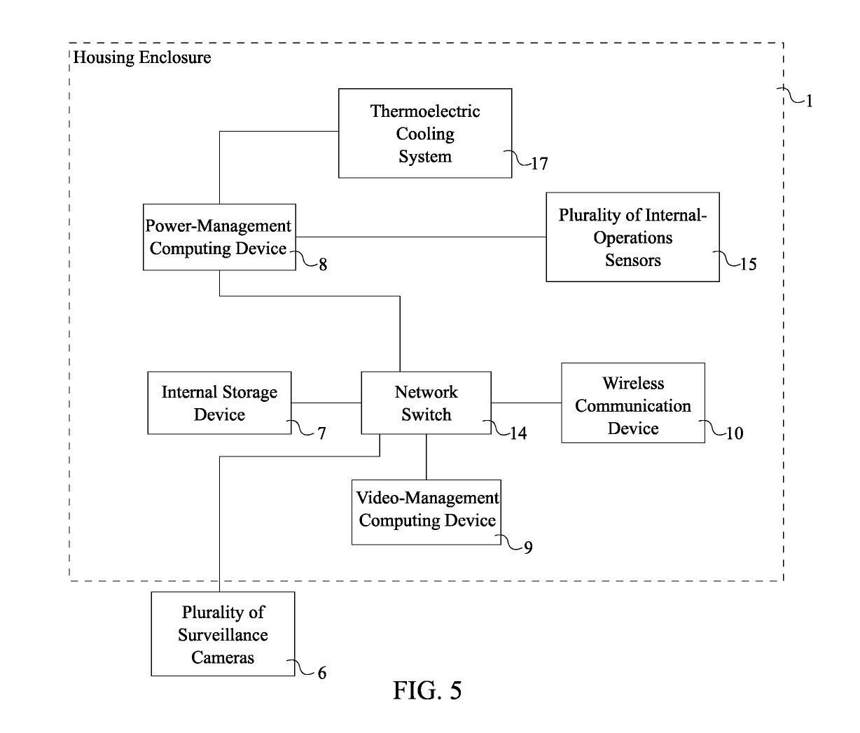

The internal storage device 7, the power-management computing device 8, the video-management computing device 9, the wireless communication router 10, and the network switch 14 manage and power the plurality of surveillance cameras 6. Referring to FIG. 4 and FIG. 5, the internal storage device 7, the power-management computing device 8, the video-management computing device 9, the wireless communication router 10, and the network switch 14 are mounted within the housing enclosure 1. The internal storage device 7 is a personal computer coupled with a conventional hard-disk drive, solid-state driven, or other similar data storage device. The internal storage device 7 locally stores the video, audio, and other content recorded by the plurality of surveillance cameras 6 and managed via a plurality of video management systems. Resultantly, the present invention is capable of storing recorded content for a significantly longer period of time when compared to traditional systems. This drastically reduces the number of downloads required by the user and reduces the cost of constantly having to stream content to an external device or an external storage device.

The power-management computing device 8 converts multiple power inputs into multiple output voltages to power the electronic components of the present invention. The video-management computing device 9 receives content recorded by the plurality of surveillance cameras 6, process said content, and stores said content on the internal storage device 7. This includes filtering the content based on specific cameras from the plurality of surveillance cameras 6, filtering noise out, and utilizing various camera software in order obtain a clear picture of the surrounding area and environment. The wireless communication router 10 connects the present invention to an external device directly or through the internet. In particular, the wireless communication router 10 is a cellular or a wireless local area network. The provides the user with remote access and control over the present invention. For this, the wireless communication router 10, the power-management computing device 8, the video-management computing device 9, the plurality of surveillance cameras 6, the internal storage device 7, are all electronically connected to each other by the network switch 14 as seen in FIG. 5. The network switch 14 is a computer networking device which connects the aforementioned components together in order to form a computer network to receive, process, and forward data to the user.

Referring to FIG. 4, the power supply 11 provides the electrical power required for the operations of the present invention. More specifically, the power supply 11 is electrically connected to the plurality of surveillance cameras 6, the power-management computing device 8, the video-management computing device 9, the wireless communication router 10, the internal storage device 7, and the network switch 14. A variety of devices and electrical sources may be used as the power supply 11. In one embodiment of the present invention, the power supply 11 is an external power source that is connected to the present invention through an ethernet cable, also known as powe-over-ethernet (POE). This decreases the number of cables necessary for the present invention for easier installment. In one embodiment of the present invention, the power supply 11 is a plurality of solar panels. In this embodiment, the plurality of solar panels may be mounted onto the housing enclosure 1 or mounted in the vicinity of the housing enclosure 1.

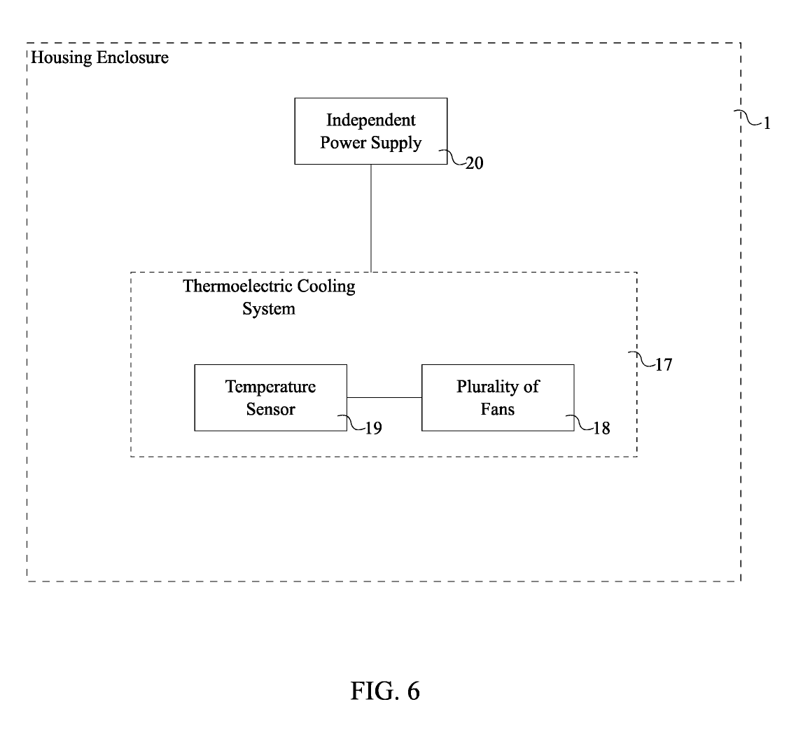

Referring to FIG. 5 and FIG. 6, the present invention is temperature controlled through a thermoelectric cooling system 17 and an independent power supply 20. The thermoelectric cooling system 17 comprises a plurality of fans 18 and an at least one temperature sensor 19. The plurality of fans 18 and thermoelectric modules cool the internal heat sinks and circulate cool air throughout the internal space of the housing enclosure 1 to cool off the internal electrical components of the present invention. This prevents the internal electrical components from overheating and failing, thus increasing the longevity of the present invention and reducing the need for maintenance. For this, the plurality of fans 18 is internally mounted within the housing enclosure 1. The temperature sensor 19 is internally mounted within the housing enclosure 1 to record the internal temperature. This is used as part of a feedback loop such that the present invention can self-regulate the internal temperature. The independent power supply 20 powers the thermoelectric cooling system 17, even if the power supply 11, the main power source, is compromised in anyway.

Referring to FIG. 2, the internal space of the housing enclosure 1 is also highly customizable and can be easily modified. In particular, the housing enclosure 1 further comprises an at least one support rack 16. The support rack 16 is a framework of bars or wires designed to support and hold items. The support rack 16 is positioned within the housing enclosure 1 and is oriented parallel to the bottom surface 5. Additionally, the support rack 16 is slidably engaged with the housing enclosure 1 for easy removal and installation. The internal storage device 7, the power-management computing device 8, the video-management computing device 9, the network switch 14, and the wireless communication router 10 are mounted to the housing enclosure 1 by the support rack 16. In the preferred embodiment of the present invention, the at least one support rack 16 includes two rack which hold the aforementioned components.

Referring to FIG. 3, the plurality of surveillance cameras 6 is mounted to the housing enclosure 1 through a plurality of omni-adjustable mounting-masts 13. The plurality of omni-adjustable mounting-masts 13 acts as an attachment point for the plurality of surveillance cameras 6 and can accommodate multiple sizes and types of cameras including, but not limited to, thermal cameras, fixed dome, fish eye cameras, infrared cameras, and other conventional cameras. Each of the plurality omni-adjustable mounting-masts 13 comprises an elongated mount that is capable of rotating and tilting relative to the bottom suface. This allows the user to position and orient each of the plurality of surveillance cameras 6 individually to cover a variety of different environments. The plurality of omni-adjustable mounting-masts 13 is distributed about the bottom surface 5 with each of the plurality of omni-adjustable mounting-masts 13 being normally connected to the bottom surface 5. Additionally, each of the plurality of surveillance cameras 6 is adjacently attached to a corresponding mounting-mast from the plurality of omni-adjustable mounting-masts 13. In an alternative embodiment of the present invention, each of the plurality of omni-adjustable mounting-masts 13 includes a rotating and or tilting mechanism which allows the user to remote rotate and or tilt each of the plurality of surveillance cameras 6.

Referring to FIG. 5, the present invention may also comprise a plurality of internal-operations sensors 15. The plurality of internal-operations sensors 15 monitors the operating environment of the present invention. Each of the plurality of internal-operations sensors 15 is internally mounted within the housing enclosure 1. In particular, the plurality of internal-operations sensors 15 is embedded onto the main PCBA and embedded into a single computer or disposed externally to the single computer. Additionally, the plurality of internal-operations sensors 15 is electrically connected to the power-management computing device 8 in order to record, manage, and send the data to the user. In one embodiment of the present invention, the plurality of internal-operations sensors 15 includes a voltage sensor and a current sensor. This allows the present invention to monitor and control operation parameters such as start-up parameters, power consumption, current load, 24-power graphs, and other similar data. Included in the operational parameters is the operating temperature recorded by the temperature sensor 19 from the thermoelectric cooling system 17. All this information is streamed to the user through the internet.

Along with the hardware, the present invention utilizes a proprietary graphical user interface giving the user two-way communication with the electrical components of the present invention via the internet, from any smart device anywhere in the world. The graphical user interface can be accessed remotely and provides the user two-way communication to the on-board devices. The user is provided information such as internal enclosure temperature, pre-programmed pre-sets for climate control, self-cleaning, start-up parameters, power consumption, current load, and 24-hour power and temperature graphs. The present invention also allows the user to remotely re-boot the electrical components of the present invention in the event of failure. Traditionally, if a device failure occurs, a service technician would have to be dispatched to manually re-boot the device. In alternate embodiments of the present invention, the present invention may operate based on internal presets and in the case of failure, the system automatically re-boots.

Although the invention has been explained in relation to its preferred embodiment, it is to be understood that many other possible modifications and variations can be made without departing from the spirit and scope of the invention as hereinafter claimed.

What is claimed is:

1. A mountable video recording and streaming system comprises:
a housing enclosure;
a plurality of surveillance cameras;
an at least one internal storage device;
a power-management computing device;
a video-management computing device;
a wireless communication router;
a power supply;
the plurality of surveillance cameras being distributed about a bottom surface of the housing enclosure;
each of the plurality of surveillance cameras being externally mounted to the bottom surface;
the internal storage device, the power-management computing device, the video-management computing device, and the wireless communication router being internally mounted within the housing enclosure;
the wireless communication router, the power-management computing device, the video-management computing device, the plurality of surveillance cameras, and the internal storage device being electronically connected to each other; and
the power supply being electrically connected to the plurality of surveillance cameras, the internal storage device, the power-management computing device, the video-management computing device, and the wireless communication router.

2. The mountable video recording and streaming system as claimed in claim 1 comprises:
a plurality of omni-adjustable mounting-masts;
the plurality of omni-adjustable mounting-masts being distributed about the bottom surface;
each of the plurality of omni-adjustable mounting-masts being normally connected to the bottom surface; and
each of the plurality of surveillance cameras being adjacently attached to a corresponding mounting-mast from the plurality of omni-adjustable mounting-masts.

3. The mountable video recording and streaming system as claimed in claim 1, wherein the power supply is a power over ethernet (POE).

4. The mountable video recording and streaming system as claimed in claim 1 comprises:
a network switch;
the network switch being internally mounted within the housing enclosure;
the network switch being electrically connected to the power supply; and
the wireless communication router, the power-management computing device, the video-management computing device, the plurality of surveillance cameras, and the internal storage device being electronically connected to each other by the network switch.

5. The mountable video recording and streaming system as claimed in claim 1 comprises:
a plurality of internal-operations sensors;
each the plurality of internal-operations sensors being internally mounted within the housing enclosure; and
the plurality of internal-operations sensors being electronically connected to the power-management computing device.

6. The mountable video recording and streaming system as claimed in claim 1, wherein the plurality of internal-operations sensors comprises a voltage sensor and a current sensor.

7. The mountable video recording and streaming system as claimed in claim 1 comprises:
the housing enclosure comprises a front portion, a rear portion, and an at least one fastening mechanism;
the rear portion being positioned adjacent to a main cavity of the front portion;
the rear portion being hingedly attached to the front portion; and
the fastening mechanism being mechanically integrated in between the front portion and the rear portion.

8. The mountable video recording and streaming system as claimed in claim 1 comprises:
a mounting bracket;
the mounting bracket being perpendicularly oriented to the bottom surface; and
the mounting bracket being externally and adjacently connected to a rear portion of the housing enclosure.

9. The mountable video recording and streaming system as claimed in claim 1 comprises:
the housing enclosure further comprises an at least one support rack;
the support rack being positioned within the housing enclosure;
the support rack being oriented parallel to the bottom surface;
the support rack being slidably engaged with the housing enclosure; and
the internal storage device, the power-management computing device, the video-management computing device, and the wireless communication router being mounted to the housing enclosure through the support rack.

10. The mountable video recording and streaming system as claimed in claim 1 comprises:
a thermoelectric cooling system;
an independent power supply;
the thermoelectric cooling system comprises a plurality of fans and an at least one temperature sensor;
the plurality of fans being internally mounted within the housing enclosure;
the temperature sensor being internally mounted within the housing enclosure;
the thermoelectric cooling system being electronically connected to the power-management computing device; and
the thermoelectric cooling system being electrically connected to the independent power supply.

11. The mountable video recording and streaming system as claimed in claim 1, wherein the housing enclosure is a weather tight polycarbonate enclosure.

12. A mountable video recording and streaming system comprises:
a housing enclosure;
a plurality of surveillance cameras;
an at least one internal storage device;
a power-management computing device;
a video-management computing device;
a wireless communication router;
a power supply;
a network switch;
the plurality of surveillance cameras being distributed about a bottom surface of the housing enclosure;
each of the plurality of surveillance cameras being externally mounted to the bottom surface;
the internal storage device, the power-management computing device, the video-management computing device, and the wireless communication router being internally mounted within the housing enclosure;
the wireless communication router, the power-management computing device, the video-management computing device, the plurality of surveillance cameras, and the internal storage device being electronically connected to each other;
the power supply being electrically connected to the plurality of surveillance cameras, the internal storage device, the power-management computing device, the video-management computing device, and the wireless communication router;
the network switch being internally mounted within the housing enclosure;
the network switch being electrically connected to the power supply; and
the wireless communication router, the power-management computing device, the video-management computing device, the plurality of surveillance cameras, and the internal storage device being electronically connected to each other by the network switch.

13. The mountable video recording and streaming system as claimed in claim 12 comprises:
a plurality of omni-adjustable mounting-masts;
the plurality of omni-adjustable mounting-masts being distributed about the bottom surface;
each of the plurality of omni-adjustable mounting-masts being normally connected to the bottom surface; and
each of the plurality of surveillance cameras being adjacently attached to a corresponding mounting-mast from the plurality of omni-adjustable mounting-masts.

14. The mountable video recording and streaming system as claimed in claim 12, wherein the power supply is a power over ethernet (POE).

15. The mountable video recording and streaming system as claimed in claim 12 comprises:
a plurality of internal-operations sensors;
each the plurality of internal-operations sensors being internally mounted within the housing enclosure; and
the plurality of internal-operations sensors being electronically connected to the power-management computing device.

16. The mountable video recording and streaming system as claimed in claim 12, wherein the plurality of internal-operations sensors comprises a voltage sensor and a current sensor.

17. The mountable video recording and streaming system as claimed in claim 12 comprises:
the housing enclosure being a weather tight polycarbonate enclosure;
the housing enclosure comprises a front portion, a rear portion, and an at least one fastening mechanism;
the rear portion being positioned adjacent to a main cavity of the front portion;
the rear portion being hingedly attached to the front portion; and
the fastening mechanism being mechanically integrated in between the front portion and the rear portion.

18. The mountable video recording and streaming system as claimed in claim 12 comprises:
a mounting bracket;
the mounting bracket being perpendicularly oriented to the bottom surface; and
the mounting bracket being externally and adjacently connected to a rear portion of the housing enclosure.

19. The mountable video recording and streaming system as claimed in claim 12 comprises:
the housing enclosure further comprises an at least one support rack;
the support rack being positioned within the housing enclosure;
the support rack being oriented parallel to the bottom surface;
the support rack being slidably engaged with the housing enclosure; and
the internal storage device, the power-management computing device, the video-management computing device, and the wireless communication router being mounted to the housing enclosure through the support rack.

20. The mountable video recording and streaming system as claimed in claim 12 comprises:
a thermoelectric cooling system;
an independent power supply;
the thermoelectric cooling system comprises a plurality of fans and an at least one temperature sensor;
the plurality of fans being internally mounted within the housing enclosure;
the temperature sensor being internally mounted within the housing enclosure;
the thermoelectric cooling system being electronically connected to the power-management computing device; and
the thermoelectric cooling system being electrically connected to the independent power supply.
